(19) United States
(12) Patent Application Publication
(10) Pub. No.: US 2026/0343242 A1
(43) Pub. Date: Oct. 29, 2026

(54) MULTI-OPERATOR SPECTRUM SHARING

(71) Applicant: DISH Wireless L.L.C., Littleton, CO (US)

(72) Inventors: Mehdi Alasti, Arlington, VA (US); Sourabh Gupta, Ashburn, VA (US)

(21) Appl. No.: 19/191,806

(22) Filed: Apr. 28, 2025

(51) Int. Cl. H04W 16/14; H04W 56/00

(52) U.S. Cl. CPC H04W 16/14; H04W 56/001

(57) ABSTRACT

Techniques for spectrum sharing between different wireless operators are described. An example method includes determining an allocation of a wireless spectrum channel between a first wireless operator and a second wireless operator within a cellular network; dividing the wireless spectrum channel into at least a first bandwidth part and a second bandwidth part based on the allocation; causing the first bandwidth part to be assigned to one or more first user equipment (UE) of the first wireless operator; causing the second bandwidth part to be assigned to one or more second UE of the second wireless operator; determining to adjust the allocation of the wireless spectrum channel between the first wireless operator and the second wireless operator; and causing the one or more first UE of the first wireless operator and the one or more second UE of the second wireless operator to be assigned an updated allocation.

### BACKGROUND

Today, there are many different technologies to share resources provided by cellular networks. For example, multi-operator core network (MOCN) and multi-operator radio access network (MORAN) allows different wireless operators to share infrastructure (e.g., cell towers, antennas, buildings to store equipment . . . ) of a cellular network provided by a mobile network operator (MNO). User equipment (UE) of different wireless operators accessing shared cells select one of the public land mobile network identifier (PLMNs) broadcasted by the cell tower and communicate this selection to the gNodeB, which connects the UEs to the selected core network. MOCN can be used when a wireless carrier would like to provide spectrum that they do not have. Sharing resources and spectrum of a cellular network, however, can be challenging.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for spectrum sharing including determining, using one or more processors, an allocation of a wireless spectrum channel between a first wireless operator and a second wireless operator within a cellular network; dividing, using the one or more processors, the wireless spectrum channel into at least a first bandwidth part and a second bandwidth part based on the allocation; causing, using the one or more processors, the first bandwidth part to be assigned to one or more first user equipment (UE) of the first wireless operator; causing, using the one or more processors, the second bandwidth part to be assigned to one or more second UE of the second wireless operator; determining, using the one or more processors, to adjust the allocation of the wireless spectrum channel between the first wireless operator and the second wireless operator; and causing the one or more first UE of the first wireless operator and the one or more second UE of the second wireless operator to be assigned an updated allocation.

One general aspect includes a system. The system also includes first devices associated with a first wireless operator wirelessly connected to a cellular network; second devices associated with a second wireless operator wirelessly connected to the cellular network; and a bandwidth allocation service connected to the cellular network that is configured to: determine an allocation of a wireless spectrum channel between the first wireless operator and the second wireless operator; divide the wireless spectrum channel into at least a first bandwidth part and a second bandwidth part based on the allocation; cause the first bandwidth part to be assigned to one or more first user equipment (UE) of the first wireless operator; cause the second bandwidth part to be assigned to one or more second UE of the second wireless operator; determine to adjust the allocation of the wireless spectrum channel between the first wireless operator and the second wireless operator; and cause the one or more first UE of the first wireless operator and the one or more second UE of the second wireless operator to be assigned an updated allocation. Other examples of this aspect include corresponding computer systems, apparatus, and computer programs recorded on one or more computer storage devices, each configured to perform the actions of the methods. Implementations may include one or more of the following features. Implementations of the described techniques may include hardware, a method or process, or computer software on a computer-accessible medium.

One general aspect includes a non-transitory computer-readable storage media storing computer-executable instructions that when executed by the one or more processors. The non-transitory computer-readable storage media storing computer-executable instructions to determine an allocation of a wireless spectrum channel between a first wireless operator and a second wireless operator within a cellular network; provide to one or more first user equipment (UE) of the first wireless operator and one or more second UE of the second wireless operator an indication of the allocation; determine to adjust the allocation of the wireless spectrum channel between the first wireless operator and the second wireless operator; and provide to the one or more first UE of the first wireless operator and the one or more second UE of the second wireless operator an indication of an updated allocation.

Other examples of this aspect include corresponding computer systems, apparatus, and computer programs recorded on one or more computer storage devices, each configured to perform the actions of the methods. Implementations of the described techniques may include hardware, a method or process, or computer software on a computer-accessible medium.

### BRIEF DESCRIPTION OF THE DRAWINGS

FIG. 1 illustrates an example system architecture of an O-RAN, in accordance with the present disclosure.

FIG. 2 illustrates a system architecture of a 5G O-RAN implemented in a cloud, in accordance with the present disclosure.

FIG. 3 is a schematic diagram illustrating an example communications system that can be used in multi-operator spectrum sharing, in accordance with the present disclosure.

FIG. 4 illustrates an example system that can facilitate multi-operator spectrum sharing, in accordance with the present disclosure.

FIG. 5 illustrates an example of dividing a wireless spectrum channel into bandwidth parts at different times, in accordance with the present disclosure.

FIG. 6 illustrates an example of sharing an RU between wireless operators or each wireless operator using different RUs in multi-operator spectrum sharing, in accordance with the present disclosure.

FIG. 7 illustrates an example of using designated synchronization signal blocks (SSBs), or shared SSBs in multi-operator spectrum sharing, in accordance with the present disclosure.

FIG. 8 illustrates an example of SSBs pointing to a control resource set (CORSET) in multi-operator spectrum sharing, in accordance with the present disclosure.

FIG. 9 is a flow diagram illustrating an example method for multi-operator spectrum sharing, in accordance with the present disclosure.

FIG. 10 is a flow diagram illustrating an example method for adjusting an allocation of wireless spectrum, in accordance with the present disclosure.

FIG. 11 is a flow diagram illustrating an example method for transmitting synchronization signal block (SSB) to UEs, in accordance with the present disclosure.

FIG. 12 provides a schematic illustration of one example of a computer system that can perform some or all of the steps of the methods and workflows provided by various examples.

### DETAILED DESCRIPTION

The present disclosure provides systems, devices, and methods that generally relate to multiple operator spectrum sharing. Using techniques described herein, a wireless spectrum channel is allocated to different wireless operators of a cellular network on a semi-static, or dynamic basis.

According to some configurations, two or more wireless operators operating in a wireless cellular network can share licensed wireless spectrum without interference and with minimal coordination, leveraging semi-static or dynamic resource allocation as described herein. In some examples, a wireless channel of bandwidth can be divided into distinct (non-overlapping) transmission/reception regions using concepts from bandwidth parts (BWP).

Generally, a BWP is a flexible technique to divide a wireless channel band into multiple sub-bands, that may be partially overlapping or entirely non-overlapping, and the aggregate of the sub-bands may or may not span the entire channel bandwidth, and switch between the different sub-bands depending on situation decided by the network. BWP can be specific to each user equipment (UE) that can be used to govern how the UE interacts with the shared spectrum. For example, an operator can dynamically switch between the different sub-bands depending on service level agreements (SLAs) that specify different parameters that can be used to switch between the different sub-bands (e.g., network conditions and/or traffic demands).

According to some configurations, each wireless operator that is sharing the wireless spectrum is allocated one or more sub-bands that the wireless operator can assign to the UEs of its subscribers. For example, a bandwidth allocation manager of the wireless network may allocate a first wireless operator a first sub-band (e.g., a BWP) of a first size and a second wireless operator a second sub-band of a second size. The first size of the first sub-band can be the same size and/or a different size compared to the second size of the second sub-band. The first operator may assign the first sub-band to one or more of the UEs of its subscribers, and the second wireless operator may assign the second sub-band to one or more of the UEs of its subscribers.

Instead of each wireless operator being restricted to a static sized sub-band, the size of the sub-band associated with a UE (e.g., a subscriber) can be adjusted at different times. In some examples, a bandwidth allocation manager can change the allocated bandwidth for each wireless operator based on their contractual agreements with the mobile network operator by dynamically updating the BWPs (sub-bands) associated with their UEs of its subscribers. The techniques described herein provide flexible spectrum sharing that enables semi-static (or dynamic) spectrum sharing, allowing wireless operators to efficiently share resources as traffic demands fluctuate, optimizing spectrum utilization without compromising service quality.

According to some configurations, interference between radio units (RUs) and/or other components within the cellular network can be reduced/eliminated using techniques described herein. For example, if the RUs used by the different wireless operators are synchronized in both time and frequency (maintaining orthogonality), interference can be avoided between the wireless operators, even when the wireless operators operate on adjacent spectrum blocks. By achieving time and frequency synchronization, the wireless operators can use the spectrum without needing guard-bands between their allocations (Orthogonality of RUs). Different time synchronization methods can be used to synchronize between the RUs of different operators, such as but not limited to PTP (Precision Time Protocol), GPS, and the like.

A shared RU model can also be used by the different wireless operators. If two or more of the wireless operators share the same RU infrastructure orthogonality and synchronization can be achieved (e.g., using a single inverse fast fourier transform (IFFT) process).

In some examples, each wireless operator may transmit a different synchronization signal block (SSB) to one or more of the UEs of its subscribers. According to some configurations, a shared SSB can be transmitted to the UEs of the wireless operators. Generally, a SSB is a signal transmitted by a base station that is used by a UE to synchronize with the cellular network by providing timing and frequency information that allows the UE to identify and connect to a nearby cell tower.

A SSB may include a primary synchronization signal (PSS), a secondary synchronization signal (SSS) alongside a physical broadcast channel (PBCH) that contains a master information block (MIB). When a UE is searching for a network, the UE detects the SSB to identify a nearby cell and then decodes the MIB within the PBCH to determine network parameters, such as the System Frame Number (SFN), cell identity, subcarrier spacing, and other necessary system parameters for initial access.

According to some configurations, each wireless operator transmits its own SSB (PSS, SSS, and PBCH/MIB) to provide time and frequency synchronization for the UEs within the shared channel bandwidth. The SSBs from different wireless operators can overlap in the frequency domain but not in the time domain, overlap in the time domain but not in the frequency domain, or not overlap in either the frequency domain or the time domain, based on the coordination or configuration between the different wireless operators.

In some examples, a single SSB (e.g., a shared SSB) is used for synchronization across the UEs of the different wireless operators. According to some configurations, the shared SSB can have a single PSS and a single SSS for all UEs. The PBCH/MIB could either be shared (e.g., if standardized) or each wireless operator can transmit its own distinct PBCH/MIB within the shared SSB framework.

According to some examples, a distinct SIB1 & CORESET 0 is used by each wireless operator. Generally, a SIB1 includes the information for a UE to determine if it can access a cell site and includes radio resource configuration information that can be used to perform an attachment procedure. For instance, each of the wireless operators can be allocated a unique SIB1 for broadcasting system information to its UEs and a distinct CORESET 0 that carries the PDCCH and DCI necessary for delivering the SIB1. The resource allocation for each CORESET 0 (time and frequency) can be determined by the PBCH which carries MIB.

In some configurations, where each of the wireless operators transmits its own SSB, each MIB points to a distinct CORESET 0, which in turn points to the operator's unique system information block (SIB1). When the different wireless operators transmit a shared SSB, the MIB format can be modified to support multi-operator spectrum sharing. With distinct MIBs for each operator each shared SSB transmits multiple MIBs (e.g. if standardized), where each MIB points to a distinct CORESET 0 corresponding to the respective operator's SIB1. If a single MIB is shared among multiple operators (e.g., if standardized), the MIB must be enhanced to carry information for multiple CORESET 0s, each pointing to a distinct SIB1 for different operators.

After each UE reads the SIB1 corresponding to its wireless operator the following steps can be performed. The UE initiates a RRC connection with the CU-CP of its designated operator. The UE sends a Registration Request to the AMF of the selected operator to begin the network registration process. The UE undergoes authentication with the operator's core network to verify its identity and establish a trusted connection. Security Setup: Security keys are established to ensure secure communication, including both: NAS security with the AMF and RRC security with the CU-CP of the relevant operator. The AMF sends a Registration Accept message confirming successful registration, providing the UE with its 5G-GUTI and other configuration details. The RRC is reconfigured based on the UE's capabilities, including BWP configuration to align with the operator's spectrum allocation. Finally, the UE initiates a PDU Session to establish a data connection with the relevant operator, setting up the necessary data channels for communication.

Using the techniques described herein provide many benefits, such as that the limited radio frequency resources available within a cellular network can be optimized as demand for wireless services increases. Spectral efficiency may also be enhanced, thereby improving network capacity, coverage, and reducing costs. This helps to encourage innovation and benefits consumers through improved service quality. Aspects of the disclosed technology address these, and other issues, as further discussed herein. Further detail regarding such example and additional examples is provided in relation to the figures. Embodiments detailed herein can be used in various types of cellular networks, such as a 5G New Radio (NR) cellular network.

### Example O-RAN

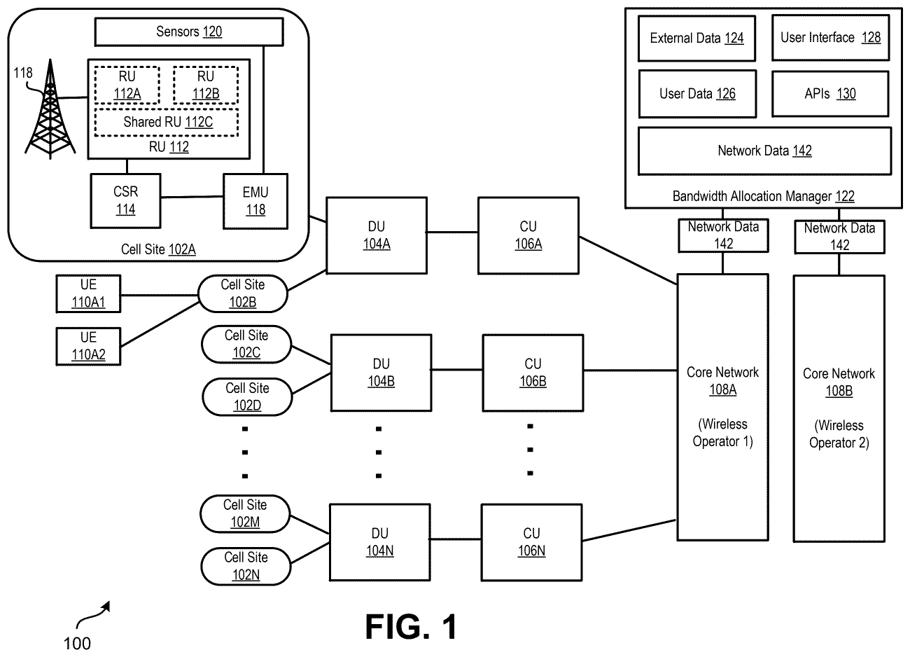

As shown in FIG. 1, the example system architecture 100 of an O-RAN in accordance with the present disclosure comprises multiple cell sites, such as cell sites 102A, B, C, D, . . . , N, N+1. As illustrated in this example, within a given cell site, such as 102A, one or more radio units (RU) are installed in the O-RAN in accordance with the present disclosure. A given one of the RUs, such as RU 112, in a given cell site, such as cell site 102A, comprises hardware components such as radio frequency (RF) transceivers, antennas configured to transmit and receive RF signals from/to end user equipment (UE), such as smartphones. In some configurations, a cell site 102 can have more than one RU 112, such as RU 112A that can be associated with a first wireless provider, and RU 112B that can be associated with a second wireless provider. According to some examples, an RU 112, such as shared RU 112C, can be shared by the different wireless providers operating within the cellular network.

As illustrated, a cell site 102, such as cell site 102A includes a CSR (cell site router) 114 coupled to EMU 118 and RU 112. The EMU 118 is coupled to one or more sensors 120. In various implementations, EMUs and/or RUs in different cell sites 102 in the example system architecture 100 can be provided by different hardware vendors. While EMU 118, sensors 120, and CSR 114 are only illustrated in cell site 102A, an EMU 118, sensors 120, and CSR 114 can be included in all, or a portion, of the cell sites 102A-102N. It is contemplated that in some examples, the cell sites in the example system architecture 100 are heterogenous in terms of hardware they are implemented in.

Also shown in FIG. 1 are distributed units (DUs) 104A, 104B . . . and 104N. A given one of the DUs, such as 104A in this example, is configured to facilitate real-time baseband processing function. Various protocols can be configured into the given DU, such as High-PHY, MAC, and RLC and/or any other lower-level protocols. In various implementations, the given DU is configured to communicate with at least one RU in a cell site. For example, as shown in this example, the DU 104A is configured to communicate with the RUs in cell sites 102A and 102B, the DU 104A is configured to communicate with the RUs in cell sites 102C and 102D, and DU 104N is configured to communicated with the RUs in cell sites in 102N and 102N+1. It should be understood that the communications illustrated between the DUs and the cell sites in FIG. 1 are merely illustrative and thus should not be understood as limiting a scope of the O-RAN in accordance with the present disclosure. That is, the O-RAN in accordance with the present disclosure is not limited to one DU connected only to two cell sites as illustrated in FIG. 1. One skilled in the art understands that the O-RAN in accordance with the present disclosure can comprise a DU configured to however many cell sites.

A given communication link between a given DU and given RU in a cell site is typically referred to as a fronthaul haul-for example, the links between cell sites 102A/B and DU 104A. In that example, the DU 104A is configured to consolidate and process inbound traffic from RUs in the cell sites 102A/B, distributes traffic to the RUs in the cell sites 102A/B. In implementations, the DUs can be located near the cell sites they have communication with or centralized in a local data center provided by a vendor. In some implementations, various functionalities in the DUs can be implemented using software.

Still shown in FIG. 1 are central units (CUs), such as CU 106A, 106B, and 106N. A given one of the CUs is configured to handle higher layers of communication protocols as compared to a DU. For example, less time-sensitive packet processing, such as PDCP, SDAP, and RRC, may be implemented in the given CU. It should be understood that functionality split between CU and DU is not intended to be specifically limited in the present disclosure. It is understood that such a split can be a design choice for a particular O-RAN. That is, the present disclosure should not be understood as being limited to a specific version or specific versions of O-RAN, where splits between CU and DU are specifically defined. For example, a DU may be separate from the RU and a CU, the DU can be co-located with the CU, or the DU can be bundled with the RU. The DU can also run standalone and/or be within a pool of DUs. Collectively, RUs, DUs, and a CU can create a gNodeB, which serves as a radio access network (RAN) of example system architecture 100.

In implementations, CUs in an O-RAN in accordance with the present disclosure can be implemented using software. In some examples, the given CU may be located in a data center provided by a third-party vendor. In some examples, one or more of the given CU can be located in the data center. The individual links between a CU and DU is typically referred to as a midhual link (i.e., the F1 interface), for example the link between 104A and 106A shown in this example.

FIG. 1 also shows core networks 108, such as core network 108A associated with a first wireless operator and core network 108B associated with a second wireless operator. A core network 108 is configured to enable end users to access services such as phone calls, internet, etc. In various examples, the core network 108 is configured to handle operations such as subscriber location, profile, authentication, and/or any other operations. In those examples, such operations can facilitate the end users to employ communication technologies (such as 5G) through the example system architecture 100. In some examples, the services and/or operations provided by the core network 108 are implemented using software. Although only one core network 108 is shown in FIG. 1, this is not intended to be limiting. It should be understood the example system architecture 100 is not intended to be limited to 5G. It is understood examples provided herein can be applied to other types of cell sites when appropriate, such as LTE, 3G, 5G, WIFI or any other types of networks.

In various other examples, more than one core network 108 is associated with the O-RAN based RAN in accordance with the present disclosure. Links between a CU and the core network 108 are typically referred to as backhaul links, for example, the link between CU 106A and core network 108 shown in this example. The fronthaul links, midhaul links, and backhaul links shown in FIG. 1 may be collectively referred to as a transport layer for the example system architecture 100. In various examples, the transport layer is configured to handle end-to-end communication over the O-RAN in accordance with the present disclosure.

Today, there are many different technologies to share resources provided by cellular networks. For example, multi-operator core network (MOCN) and multi-operator radio access network (MORAN) allows different wireless operators to share infrastructure (e.g., cell towers, antennas, buildings to store equipment . . . ) of a cellular network provided by a mobile network operator (MNO). Using MORAN, different wireless operators share baseband units (BBUs), remote radio units (RRUs), active antenna units (AAUs), RUs, DUs, and CUs. The RAN infrastructure provides logically and physically separated cell resources and core network connectivity on a per-operator basis. When using MOCN, the wireless operators are configured to use frequency sharing. In order to frequency share, the wireless network may perform frequency sharing according to service level agreements with the different wireless carriers. Each wireless operators may use their own core network. UEs accessing shared cells select one of the public land mobile network identifier (PLMNs) broadcasted by the cell tower and communicate this selection to the gNodeB, which connects the UEs to the selected core network. MOCN can be used when a wireless carrier would like to provide spectrum that they do not have.

Using techniques described herein, a wireless spectrum channel is allocated by a bandwidth allocation manager 122 to different wireless operators of a cellular network on a semi-static, or dynamic basis. According to some configurations, two or more wireless operators operating in a wireless cellular network can share licensed wireless spectrum without interference and with minimal coordination, leveraging semi-static or dynamic resource allocation as described herein. In some examples, the bandwidth allocation manager 122 divides a wireless channel of bandwidth into distinct (non-overlapping) transmission/reception regions (sub-bands).

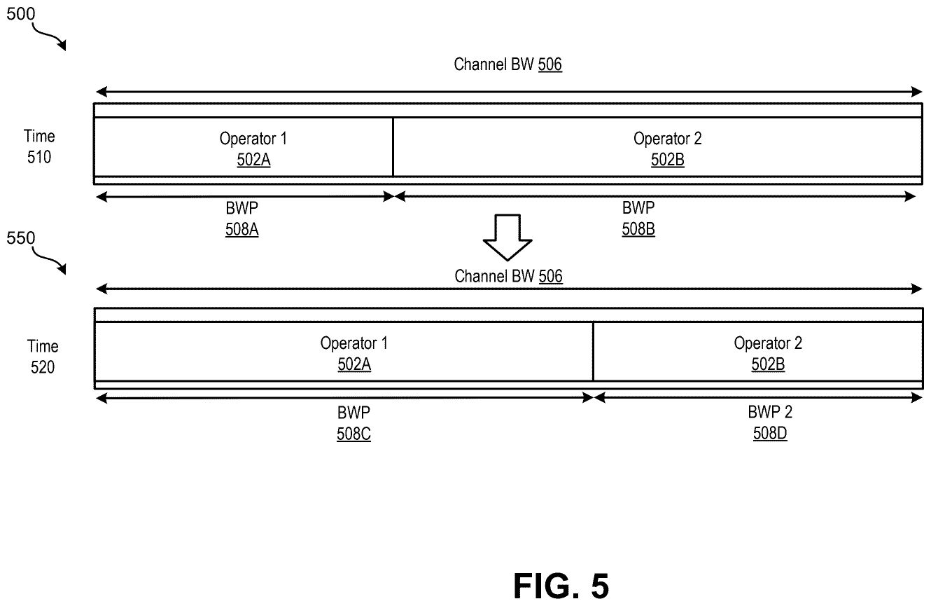

According to some configurations, each wireless operator that is sharing the wireless spectrum is allocated one or more of the BWPs by the bandwidth allocation manager 122. Once allocated the wireless operator, or some other component/device, can assign the allocated BWP(s) to one or more of the UEs of its subscribers. For example, as illustrated in FIG. 5, the bandwidth allocation manager 122 may allocate a first wireless operator a first sub-band (e.g., a BWP) of a first size and a second wireless operator a second sub-band of a second size. The first size of the first sub-band can be the same size and/or a different size compared to the second size of the second sub-band. The first operator may assign the first sub-band to one or more of the UEs of its subscribers, and the second wireless operator may assign the second sub-band to one or more of the UEs of its subscribers.

Instead of each wireless operator being restricted to a static sized sub-band, the size of the sub-band associated with a UE (e.g., a subscriber) can be adjusted by the bandwidth allocation manager 122 at different times. In some examples, the bandwidth allocation manager 122 can change the allocated bandwidth for each wireless operator based on their contractual agreements with the mobile network operator by dynamically updating the BWPs associated with their UEs of its subscribers. These techniques provide flexible spectrum sharing that enables semi-static (or dynamic) spectrum sharing, allowing wireless operators to efficiently share resources as traffic demands fluctuate, optimizing spectrum utilization without compromising service quality.

According to some configurations, interference between RUs 112 and/or other components within the cellular network can be reduced/eliminated using techniques described herein. For example, if the RUs 122 used by the different wireless operators are synchronized in both time and frequency (maintaining orthogonality), interference can be avoided between the wireless operators, even when the wireless operators operate on adjacent spectrum blocks. By achieving time and frequency synchronization, the wireless operators can use the spectrum without needing guard-bands between their allocations (Orthogonality of RUs). Different time synchronization methods can be used to synchronize between the RUs of different operators, such as but not limited to PTP (Precision Time Protocol), GPS, and the like.

A shared RU 112 can also be used by the different wireless operators. If two or more of the wireless operators share the same RU infrastructure orthogonality and synchronization can be achieved (e.g., using a single inverse fast Fourier transform (IFFT) process). More details on multi-operator spectrum sharing are described below.

As illustrated, a bandwidth allocation manager 122 is coupled to networks, such as core networks 108 (e.g., core network 108A and core network 108B). In other examples, the bandwidth allocation manager 122 can be coupled to O-RAN RIC (RAN Intelligent Controller), an OAM (Operations and Maintenance Architecture) platform, and the like. The bandwidth allocation manager 122 is configured to interact with components deployed within the cellular network and deployed at cell sites 102. As briefly discussed above, the bandwidth allocation manager 122 can be configured to interact with different components within the network 108 and at other locations within the cellular network. For instance, the bandwidth allocation manager 122 may communicate with different brands of components (e.g., RUs 112, EMUs 118, . . . ) deployed at cell sites 120 and provided by different suppliers/vendors using the same application/tool/UI (user interface). For instance, one or more of the cell sites 102 may have RUs 112, EMUs 118 from different vendors.

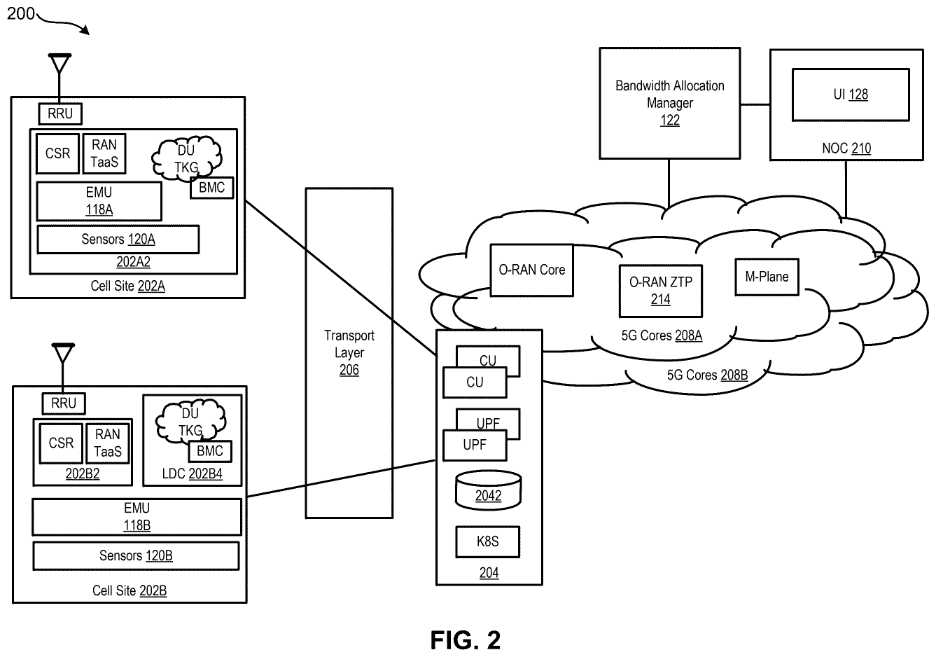

In some examples, the bandwidth allocation manager 122 connects to the components within a cell site 102 using a CSR 114. According to some configurations, the EMU 118 is connected to sensors 120 (See FIG. 2). For example, the sensors 120 can monitor different environmental parameters such as but limited to temperature, humidity, air quality, airflow, noise, vibration, pressure, water leaks, network connections, motion detection, smoke/fire detection, camera surveillance, locks (e.g., locked/unlocked), doors/windows (e.g., open/closed), switches, power levels, battery levels, light controllers, switches (e.g., on/off), uninterruptible power supply (UPS), global positioning system (GPS), microwave controllers, radio frequency Identification (RFID) card readers, door locks, light controllers, voltage standing wave ratio (VSWR) meters, heating, ventilation, and air conditioning (HVAC) controllers, and the like. The bandwidth allocation manager 122 can also obtain information related to the current performance of one or more components of the cellular network.

In some examples, the bandwidth allocation manager 122 can integrate with devices/components such as but not limited to different brands of RUs, DUs, CUs, EMUs 118, element management systems (EMSs), inventory management tools, network monitoring tools, validation/testing tools, data sharing services, and the like. According to some examples, application programming interfaces (APIs) 130 can be used to interact with functionality provided by different components. The APIs 130 may be provided by a hardware vendor, and/or be custom APIs developed to interact with one or more components.

The bandwidth allocation manager 122 can also cause an operation and/or a workflow to be performed. For example, the bandwidth allocation manager 122 may cause one or more operations to be performed such as, causing an assignment of allocated bandwidth to UEs 110.

In some examples, a user uses user interface (UI) 128 to view information about the cellular network. The UI 128 may also be used to specify one or more operations to be performed at one or more identified cell sites 102 and/or at some other location within the cellular network. In some configurations, the bandwidth allocation manager 122 determines the IP addresses of the components that are involved in the one or more operations, establishes a network connection with the identified components using the determined IP addresses, and then causes the one or more operations to be performed. In some configurations, the bandwidth allocation manager 122 can create payloads based on the component being interacted with. In some examples, when a configuration change is made to a component, an element management system (EMS) (not shown) is automatically updated to reflect the change. These techniques can be used to interact with a large number of cell sites 102, resulting in a significant cost and time savings. According to some examples, the UI 128 provides a unified interface to interact with the different brands of components deployed at different cell sites 102 of an O-RAN based RAN, view network data 142, view reports, configure parameters, enter queries against the data, and the like.

With an example system architecture 100 of O-RAN in accordance with the present disclosure having been generally described and illustrated, attention is now directed to FIG. 2, where an example system architecture 200 of an O-RAN based 5G RAN implement in a cloud is generally illustrated.

### Example System Architecture of 5G O-RAN

As shown FIG. 2, the example system architecture 200 of an O-RAN based 5G RAN comprises a cell site 202A, a cell site 202B, and/or any other cell site(s). As shown, each of the cell site 202A, and 202B, in this example, includes a remote radio unit (RRU). In this example, one or more computing devices, located outside the cell site 202B, are configured to implement a cell site router (CSR), a DU, a baseband management controller (BMC), a RAN, a RAN TaaS (test as a service), and/or any other components. In some examples, the computing device includes a processor configured to implement various components mentioned above. In some examples, the computing device(s) 202A2 includes an operating system such as a Linux system to implement these components. In that example, the computing device(s) 202A2 is located in a cabinet within a proximity of the cell site 202A, and cell site 202A is referred to as a “lite site”.

The cell site 202B includes a computing device 202B2 and another computing device 202B4. In this example, the computing devices 202B2 and 202B4 are located within the cell site 202B. In some examples, the computing devices 202B2 and 202B4 are located in a cabinet within the cell site 202B. In that example, the cell site 202B is referred to as a “dark site”.

As shown, in this example, the computing device 202B2 is configured to implement the CSR, RAN, and/or any other components, while the computing device 202B4 is configured to implement the DU (for example, hosting Tanzu Kubernetes Grid (TKG)), BMC, and/or any other components. This is to show cell sites in an O-RAN based 5G RAN in accordance with the present disclosure can have computing devices located within the cell sites and configured to implement various components whose functionalities attributed to the DU, CSR or RAN. That is, the O-RAN based 5G RAN in accordance with the present disclosure is not intended to be limited such that DU and CSR/RAN are implemented on different computing devices, and/or outside the cell site. In some examples, the RAN for a specific cell site such as 202A or 202B can include tests designed to components and functionalities within the specific cell site, functionalities with another cell site (e.g., adjacency testing), and/or end-to tend testing.

In various examples, the RAN shown in this example is implemented using software and is configured to test and ensure one or more RAN components (e.g., the RRU or CSR, in the cell sites are performing in compliance with O-RAN standards). Various tests or test suites can be configured into a RAN to cause target components in the cell sites to be run under preset test conditions. A goal of such a test or test suite in the RAN is to verify that individual components in the cell sites can handle expected traffic and functionality. In some examples, tests in the RAN are run continuously on a preset or configured frequency to ensure the above-mentioned types of testing of the specific cell sites are in compliance with the O-RAN standards continuously.

As shown FIG. 2, the cell sites 202A and 202B are connected, via the transport layer 206, to a data center 204 configured to host one or more CUs, and one or more UPFs (user plane functions) implementing at least one user plane layer, and/or any other components. In some examples, the data center 204 is referred to as a breakout edge data center (BEDC). In general, the data center 204 is configured to accommodate the distributed nature of various functions in the example system architecture 200 of a 5G O-RAN. In that example, the BEDC hosts various 5G network functions (NFs) that have low latency requirement. In that example, the BEDC provides internet peering for general 5G service and enterprise customer-specific private network service.

Shown in this example is a storage 2042 configured to store various (Cloud-native Network Functions) CNFs and artifacts for facilitating implementations of the DUs and CUs in the example system architecture 200 of the O-RAN based 5G RAN. Examples of the storage 2042 can include Amazon S3, GitHub, Harbor and/or any other storage services.

In some examples, such as shown in FIG. 2, the data center 204 can include one or more Kubernetes (also known as K8S) configured to facilitate automation of deployment, scaling, and management of various software/applications deployed within the data center 204 and/or within one or more cell sites operatively communicating with the data center 204 through the transport layer 206.

5G cores 208, such as 5G core 208A and 5G core 208B, can be implemented such that it is physically distributed across data centers or located at a central national data center (NDC) and/or regional data center (RDC). In this example, 5G core 208 performs various core functions of the 5G network. In implementations, 5G core 208 can connect to an O-RAN based 5G RAN implementing various 5G services and/or functions such as: network resource management components; policy management components; subscriber management components; packet control components; and/or any other 5G functions or services. Individual components may communicate on a bus, thus allowing various components of 5G core 208 to communicate with each other directly. Implementations 5G core 208 can involve additional other components.

Network resource management components can include: Network Repository Function (NRF) and Network Slice Selection Function (NSSF). NRF can allow 5G network functions (NFs) to register and discover each other via a standards-based application programming interface (API). NSSF can be used by AMF to assist with the selection of a network slice that will serve a particular UE.

Policy management components can include: Charging Function (CHF) and Policy Control Function (PCF). CHF allows charging services to be offered to authorized network functions. A converged online and offline charging can be supported. PCF allows for policy control functions and the related 5G signaling interfaces to be supported.

Subscriber management components can include: Unified Data Management (UDM) and Authentication Server Function (AUSF). UDM can allow for generation of authentication vectors, user identification handling, NF registration management, and retrieval of UE individual subscription data for slice selection. AUSF performs authentication with UE.

Packet control components can include: Access and Mobility Management Function (AMF) and Session Management Function (SMF). AMF can receive connection and session related information from UE and is responsible for handling connection and mobility management tasks. SMF is responsible for interacting with the decoupled data plane, creating updating and removing Protocol Data Unit (PDU) sessions, and managing session context with the User Plane Function (UPF).

In one O-RAN implementation, DUs, CUs, 5G core 208 and/or any other components in that O-RAN, is implemented virtually as software being executed by general-purpose computing equipment, such as those in one or more data centers. Therefore, depending on needs, the functionality of a DU, CU, and/or 5G 208 core may be implemented locally to each other and/or specific functions of any given component can be performed by physically separated server systems (e.g., at different server farms). For example, some functions of a CU may be located at a same server facility as where the DU is executed, while other functions are executed at a separate server system. In some examples, DUs may be partially or fully added to cloud-based cellular network components. Such cloud-based cellular network components may be executed as specialized software executed by underlying general-purpose computer servers. Cloud-based cellular network components may be executed on a third-party cloud-based computing platform. For instance, a separate entity that provides a cloud-based computing platform may have the ability to devote additional hardware resources to cloud-based cellular network components or implement additional instances of such components when requested.

In implementations, Kubernetes (K8S), or some other container orchestration platform, can be used to create and destroy the logical DU, CU, 5G core units and subunits as needed for the O-RAN to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU is no longer needed, Kubernetes can allow for removal of the logical DU. Kubernetes can also be used to control the flow of data (e.g., messages) and inject a flow of data to various components. This arrangement can allow for the modification of nominal behavior of various layers.

In implementations, the deployment, scaling, and management of such virtualized components can be managed by an orchestrator (such as Kubernetes) in the 5G core 208. The orchestrator can trigger various software processes executed by underlying computer hardware. In implementations, the one or more management functions (managing the 5G core 208, and/or the example system architecture 200 in general) can be implemented in the 5G core 208, for example through a M-Plane. The M-Plane can be configured to facilitate monitoring of O-RAN and determining the amount and location at which cellular network functions should be deployed to meet or attempt to meet service level agreements (SLAs) across slices of the cellular network.

In various implementations, an orchestrator (not shown) can allow for the instantiation of new cloud-based components of the example system architecture 200 of the O-RAN based 5G RAN. As an example, to upgrade an EMU 118, the orchestrator can perform a pipeline of calling the EMU upgrade code from a software repository incorporated as part of, or separate from, cellular network; pulling corresponding configuration files (e.g., helm charts); creating Kubernetes nodes/pods; configuring the EMU; and activating other support functions (e.g., connections to test tools).

In some implementations, a network slice functions as a virtual network operating on example system architecture 200 of the O-RAN based 5G RAN. In those implementations, example system architecture 200 of the O-RAN based 5G RAN is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular network slices may only be reserved in particular geographic regions. For instance, a first set of network slices may be present at a given RU and a given DU, a second set of network slices, which may only partially overlap or may be wholly different than the first set, may be reserved at the given RU and the given DU.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

In some examples, the 5G core 208 implements a O-RAN ZTP (zero touch provisioning) layer. In general, in those examples, the O-RAN ZTP layer is configured to facilitate automation of the deployment workflow within the example system architecture 200 of the 5G O-RAN. ZTP is commonly known as automated deployment of software (new or updates) to various components in a system with as little human intervention as possible. In the context of example system architecture 200 of the 5G O-RAN, ZTP means automated deployment of software (new or updates) to hardware and/or software components such as RUs, CSRs, DUs, CUs, and various modules in the 5G core 208 with little human intervention.

For example, without an engineer having to be present at a specific cell site such as 202A or 202B, O-RAN ZTP can facilitate automatic updates of a component with the latest software, suc as updates of an RU with the latest RU software, updates of a DU with the latest DU software and/or changing from one vendor's RU/DU to another vendor's RU/DU. It should be understood the O-RAN ZTP layer is referred to a set of components that work together to facilitate automatic deployment of software in the example system architecture 200 of the O-RAN based 5G RAN with little human intervention. Thus, although, the O-RAN ZTP layer is shown being implemented in the 5G core 208 in FIG. 2, it is merely illustrative. That is, the O-RAN ZTP in accordance with the present disclosure is not intended to be limited to components implemented a core of the O-RAN in accordance with the present disclosure. In some other examples, one or more components of the O-RAN ZTP can be implemented in, for example, CUs or DUs in the O-RAN in accordance with the present disclosure. For instance, as will be described below, adaptors configured to communicate with devices or components of different vendors for ZTP operations can be implemented in CUs or DUs.

Also shown in FIG. 2 is a NOC 210 (Network Operation Center). In some examples, the NOC 210 is implemented on a general-purpose computing device. In those examples, one or more interfaces are implemented in the NOC 210. In those examples, the interfaces represent virtual dashboards that can facilitate multi-operator spectrum sharing, automatic deployment of software to various components in the example system architecture 200 of the O-RAN based 5G RAN, and the like. For instance, an interface is provided in the NOC 210 to enable an operator to view data using UI 128 and/or to interact with different components at the different cell sites 102, as described herein. According to some configurations, the UI 128 can be used to view data obtained from one or more cell sites, add components/sensors/devices to a cell site, view health data associated with the cell site, and the like. According to some configurations, the bandwidth allocation manager 122 can be used to manage components installed at a cell site. In some examples, the bandwidth allocation manager 122 is configured to provide status checks for components associated with cell sites.

The NOC 210 can also be used by an operator to set a schedule to update one or more network services in the 5G core 208. As another illustration, an interface is provided in the NOC 210 to enable the operator to push software to a specific component in a cell site (such as 202A or 202B) or in a data center (such as 204) to configure or update the component. As another example, an interface is provided in the NOC 210 to enable an operator to provision one or more C-RAN components. The NOC 210 can also be used to configure alarms for one or more detected cell site conditions.

One or more requests can be generated by the NOC 210 to instigate the deployment of the software as scheduled or intended by the operator. The request(s) can be received by the O-RAN ZTP layer, which in turn can generate one or more commands to deploy the software to the component. Although one NOC 210 is shown in this example, this is not intended to be limiting. More than one NOCs are typically deployed in the example system architecture 200 of the O-RAN based 5G RAN. In some implementations, a given NOC may be provided by a vendor to the 5G O-RAN. For instance, the vendor may be a software develop that provides components or services to the example system architecture 200 of a O-RAN based 5G RAN. In that instance, the given NOC is a computing device or system on a premise of the software developer.

Components such as EMUs, RUs, DUs, CUs, the orchestrator, O-RAN ZTP layer, interfaces in the NOC 210, and/or any other components in the 5G core 208 may include various software components communicating with each other, handling large volumes of data traffic, and be able to properly respond to changes in the network. In order to ensure not only the functionality and interoperability of such components, but also the ability to respond to changing network conditions and the ability to meet or perform above vendor specifications, significant testing must be performed.

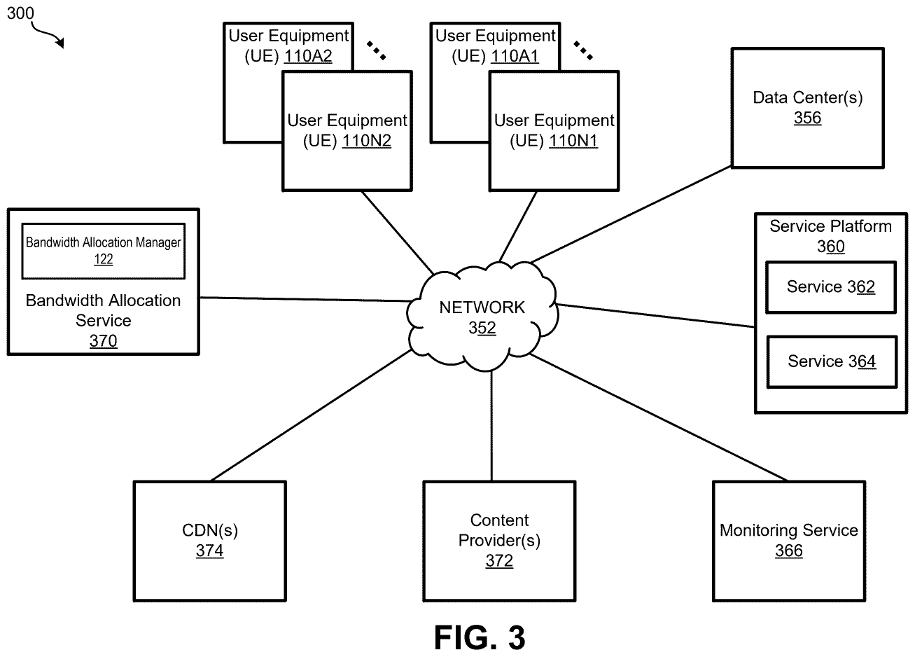

FIG. 3 is a schematic diagram illustrating an example communications system 300 that can be used in multi-operator spectrum sharing, according to various examples. The system 300 includes one or more devices, such as UEs 110A1-110N1 associated with a first wireless operator and UEs 110A2-110N2 associated with a second wireless operator. In some examples, each of the devices 110 includes a computing system (not shown). The computing system contains processing resources such as computing resources, memory device, and data storage resources. The UEs 110 are communicatively interconnected with each other through network 352. Also, UE 110 may include, or be part of, various types of devices including, but not limited to: smartphones, tablets, notebook computers, mobile devices, sensors, vehicles, autonomous vehicles, machinery, appliances, smart speakers, digital assistants, security cameras, monitoring devices, home electronics, media players, receiving devices, set-top boxes, other computing devices and IoT devices, etc.

Network 352 may also provide connectivity to other networks and geographically separated devices, such as service platform 360, monitoring service 366, bandwidth allocation service 370, and devices in data center(s) 356 (e.g., local data centers, regional data centers, national data centers), content provider(s) 372, content delivery network(s) 374, and bandwidth allocation service 370. In some examples, network 352 includes mobile core networks, associated with each of the different wireless providers, which provides subscriber profile information, subscriber location, authentication of services, and the necessary switching functions for voice and data sessions, including circuit-switched services, packet-switched services. Network 352 may also provide cloud-aligned, service-based architecture (SBA) that spans across various functions and interactions including authentication, security, session management, and aggregation of traffic from end devices.

Network 352 may also include equipment and provide functionality to provide Internet connectivity to the user equipment 110, and connectivity to other devices and systems, such as service platform 360, monitoring service 366, and devices in data center(s) 356, content provider(s) 372, content delivery network(s) 374, and the bandwidth allocation service 370, using other additional or integrated networks. For example, network 352 may include one or more computer networks, one or more wired or wireless networks, satellite transmission media, one or more cellular networks, the Internet or some combination thereof, including routers, switches, gateways and other network equipment providing such connectivity. The network 352 may include a publicly accessible network of linked networks, possibly operated by various distinct parties, such as the Internet. In some examples, the network is a 5G-based network, such as illustrated in FIG. 1 and FIG. 2 that can provide multi-operator spectrum sharing.

In some examples, the bandwidth allocation service 370 allocates a wireless spectrum channel to different wireless operators of a cellular network on a semi-static, or dynamic basis. In some examples, the bandwidth allocation manager 122 divides a wireless channel of bandwidth into distinct (non-overlapping) transmission/reception regions.

According to some configurations, each wireless operator that is sharing the wireless spectrum is allocated one or more of the sub-bands (e.g., BWPs) by the bandwidth allocation manager 122. Once allocated the wireless operator, or some other component/device, can assign the allocated BWP(s) to one or more of the UEs of its subscribers. For example, as illustrated in FIG. 5, the bandwidth allocation manager 122 may allocate a first wireless operator a first sub-band (e.g., a BWP) of a first size and a second wireless operator a second sub-band of a second size. The first size of the first sub-band can be the same size and/or a different size compared to the second size of the second sub-band. The first operator may assign the first sub-band to one or more of the UEs of its subscribers, and the second wireless operator may assign the second sub-band to one or more of the UEs of its subscribers.

Instead of each wireless operator being restricted to a static sized sub-band, the size of the sub-band associated with a UE (e.g., a subscriber) can be adjusted by the bandwidth allocation manager 122 of the bandwidth allocation service 370 at different times. In some examples, the bandwidth allocation manager 122 can change the allocated bandwidth for each wireless operator based on their contractual agreements with the mobile network operator by dynamically updating the BWPs associated with their UEs of its subscribers. These techniques provide flexible spectrum sharing that enables semi-static (or dynamic) spectrum sharing, allowing wireless operators to efficiently share resources as traffic demands fluctuate, optimizing spectrum utilization without compromising service quality.

The monitoring service 366 may include various monitoring tools for collecting real-time network data. For example, a NetFlow analyzer may be used to monitor and analyze network traffic flows in real-time and provide visibility into network bandwidth usage, application performance, and security threats by analyzing flow data generated by the network devices. Simple Network Management Protocol (SNMP) may be used to collect and analyze performance data from network devices, monitor current health status of each device, traffic utilization, and other metrics. Bandwidth monitoring tools may be used to track network bandwidth usage in real-time, monitor traffic patterns, identify bandwidth-intensive applications, and detect abnormal usage patterns that may indicate network congestion or security threats. QoS analyzer may be used to assess network performance based on predetermined service level agreements (SLAs) or QoS parameters and determine if the real-time network performance is in compliance with QoS standards. An Application Performance Monitoring (APM) tool may be used to collect data including metrics such as response time, throughput, error rates, CPU and memory utilization, database query performance, latency, and more, during execution of one or more applications.

Multi-Access Edge Computing (MEC) is an element of 5G architecture that can bring the applications from centralized data centers to the network edge, and therefore closer to end users and their devices. This essentially creates a shortcut in content delivery between the user and host, and the long network path that once separated them. Characteristics of the MEC include the low latency, last mile telecommunication, high bandwidth, high speed, and real time access to RAN information that distinguish 5G architecture from its predecessors. In some examples, this low latency, high bandwidth and real time access to an increasing number of small and macro 5G cells equipped on the 5G devices, is utilized in a unique way to tap into the available processing resources at these computing nodes.

### Example System to Facilitate Multi-Operator Spectrum Sharing

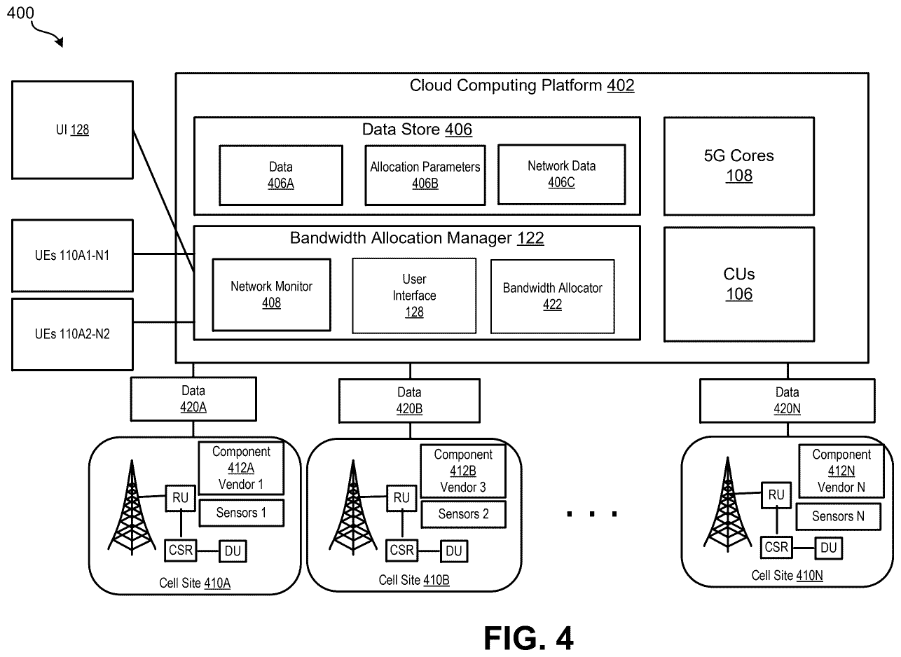

FIG. 4 illustrates an example system 400 that can facilitate multi-operator spectrum sharing, in accordance with some examples. In this example, the system 400 includes a cloud computing platform coupled to cell sites 410A-410N. The cloud computing platform 402 includes a bandwidth allocation manager 122, a data store 406, 5G cores 108, and CUs 106. As illustrated, each of the cell sites 410A-410N include one or more components 412, sensors, and a CSR.

As illustrated, a bandwidth allocation manager 122 is coupled to the networks 108. The bandwidth allocation manager 122 is configured to interact with data stores, such as data store 406, and other components deployed within the cellular network and deployed at cell sites 410. As briefly discussed above, the bandwidth allocation manager 122 also interacts with different components within the network 108 and at other locations within the cellular network, such as at cell sites 410. For instance, the bandwidth allocation manager 122 may communicate with different brands of components (e.g., RUs 112, EMUs 118, . . . ) deployed at cell sites 410 and provided by different suppliers/vendors using the same application/tool/UI. For instance, one or more of the cell sites 410 may have RUs, DUs, EMUs, and/or other components obtained from different vendors.

In some examples, the bandwidth allocation manager 122 connects to the components within a cell site 410 using a CSR. According to some configurations, an EMU is connected to sensors 120 (See FIG. 2). For example, the sensors 120 can monitor different environmental parameters such as but limited to temperature, humidity, air quality, airflow, noise, vibration, pressure, water leaks, network connections, motion detection, smoke/fire detection, camera surveillance, locks (e.g., locked/unlocked), doors/windows (e.g., open/closed), switches, power levels, battery levels, light controllers, switches (e.g., on/off), uninterruptible power supply (UPS), global positioning system (GPS), microwave controllers, radio frequency Identification (RFID) card readers, door locks, light controllers, voltage standing wave ratio (VSWR) meters, heating, ventilation, and air conditioning (HVAC) controllers, and the like.

In some examples, the bandwidth allocation manager 122 can integrate with different data sources, as well as interacting with devices/components such as but not limited to different brands of RUs, DUs, CUs, EMUs, element management systems (EMSs), inventory management tools, network monitoring tools, validation/testing tools, data sharing services, and the like. According to some examples, application programming interfaces (APIs) 130 can be used to interact with functionality provided by different components. The APIs 130 may be provided by a hardware vendor, and/or be custom APIs developed to interact with one or more components.

As discussed above, a wireless spectrum channel is allocated by a bandwidth allocation manager 122 to different wireless operators of a cellular network on a semi-static, or dynamic basis. In some examples, the bandwidth allocator 422 of the bandwidth allocation manager 122 divides a wireless channel of bandwidth into distinct (non-overlapping) transmission/reception regions. In some examples, the bandwidth allocator 422 accesses allocation parameters 406B to determine how to allocate the available wireless spectrum channel. The allocation parameters 406B may include (SLAs) that specify different parameters that can be used to switch between the different sub-bands. In some configurations, the bandwidth allocator 422 may access allocation parameters 406B and/or other data (e.g., data 406A, network data 406C that includes data 420, . . . ) an operator can dynamically switch between the different sub-bands depending on current network conditions, traffic demands, and the like.

According to some configurations, each wireless operator that is sharing the wireless spectrum is allocated one or more of the BWPs by the bandwidth allocation manager 122. Once allocated the wireless operator, or some other component/device, can assign the allocated BWP(s) to one or more of the UEs of its subscribers.

Instead of each wireless operator being restricted to a static sized sub-band, the size of the sub-band associated with a UE (e.g., a subscriber) can be adjusted by the bandwidth allocation manager 122 at different times. In some examples, the bandwidth allocation manager 122 can change the allocated bandwidth for each wireless operator based on their contractual agreements with the mobile network operator by dynamically updating the BWPs associated with their UEs of its subscribers. These techniques provide flexible spectrum sharing that enables semi-static (or dynamic) spectrum sharing, allowing wireless operators to efficiently share resources as traffic demands fluctuate, optimizing spectrum utilization without compromising service quality.

In some examples, a user uses user interface (UI) 128 to view information about the cellular network, connect and interact with different components within the cellular network, and the like. For instance, a user may request (e.g. by interacting with one or more UI elements) to view information about a current bandwidth allocation between different wireless operators that are operating within the cellular network.

The UI 128 may also be used to specify one or more operations to be performed at one or more identified cell sites 102 and/or at some other location within the cellular network. In some configurations, the bandwidth allocation manager 122 determines the IP addresses of the components that are involved in the one or more operations, establishes a network connection with the identified components using the determined IP addresses, and then causes the one or more operations to be performed. In some configurations, the bandwidth allocation manager 122 can create payloads based on the component being interacted with. In some examples, when a configuration change is made to a component, an element management system (EMS) (not shown) is automatically updated to reflect the change. These techniques can be used to interact with a large number of cell sites 102, resulting in a significant cost and time savings. According to some examples, the UI 128 provides a unified interface to interact with the different brands of components deployed at different cell sites 102 of an O-RAN, view network data 142, view KPIs 144, view reports, configure parameters, enter queries against the data, and the like.

According to some configurations, different types/brands of components, such as component 412A from vendor 1, component 412B from vendor 3, and component 412N from vendor N are deployed at different cell sites 410 associated with a cellular network. Instead of interacting with and obtaining data from a single brand of a component, data 420 is obtained from different brands of components and shared in real-time with bandwidth allocation manager 122 and/or other applications/services. The different brands of components can provide different data associated with a cell site. For example, a first brand of a component deployed at a first cell site may generate first data 420A, whereas a second brand of component deployed at a second cell site may generate data 420B that is different from data 420A.

FIG. 5 illustrates an example of dividing a wireless spectrum channel 506 into bandwidth parts 508 at different times, according to various examples of the present disclosure. As discussed above, two or more wireless operators, such as a first wireless operator 502A and a second wireless operator 502B, operating in a wireless cellular network can be allocated a portion of bandwidth (e.g., one or more bandwidth parts) from a wireless spectrum channel 506.

Instead of each wireless operator being restricted to a static sized sub-band, the size of the sub-band (e.g., the BWP) associated with a subscriber (e.g., a UE) can be adjusted at different times. In some examples, the bandwidth allocation manager 122 can adjust the allocated bandwidth for each wireless operator based on their contractual agreements with the mobile network operator by dynamically updating the BWPs associated with their subscribers (UEs). According to some examples, the bandwidth allocation manager 122 is configured to enable semi-static (or dynamic) spectrum sharing, allowing wireless operators 502 to efficiently share resources as traffic demands fluctuate, optimizing spectrum utilization without compromising service quality

According to some configurations, the bandwidth allocation manager 122 determines an allocation of bandwidth of the wireless channel based on service level agreements (SLAs) that specify different parameters that can be used to switch between the different sub-bands (e.g., network conditions and/or traffic demands). Initially, at time 510, the wireless channel bandwidth 506 is divided into distinct (non-overlapping) transmission/reception regions. In the current example, channel bandwidth 506 is initially divided into BWP 508A that is associated with a first wireless operator 502A, and BWP 508B that is associated with a second wireless operator 502B. At time 550, the wireless channel bandwidth 506 is divided into BWP 508C that is associated with the first wireless operator 502A, and BWP 508D is associated with the second wireless operator 502B. As can be seen at time 520, the size of the BWP 508C is larger than the initial size of BWP 508A that was allocated to the first operator 502A at time 510.

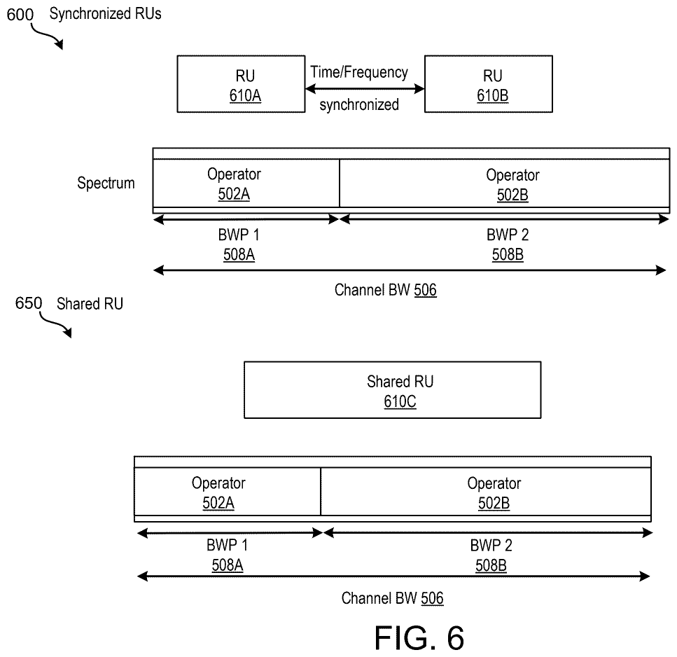

FIG. 6 illustrates an example of sharing an RU between wireless operators or each wireless operator using different RUs in multi-operator spectrum sharing, according to various examples of the present disclosure. As discussed above, two or more wireless operators operating in a wireless cellular network can be allocated a portion of bandwidth (e.g., one or more bandwidth parts) from a wireless spectrum channel.

As illustrated, element 600 shows wireless operators using different RUs. According to some configurations, interference between radio units (RUs), such as RU 610A and RU 610B can be reduced/eliminated using techniques described herein. For example, if the RU 610A and RU 610B of the different wireless operators, such as operator 502A and operator 502B, are synchronized in both time and frequency (maintaining orthogonality), interference can be avoided between the wireless operators, even when the wireless operators operate on adjacent spectrum blocks. By achieving time and frequency synchronization, operators can use the spectrum without requiring guard-bands between their allocations (Orthogonality of RUs). Different time synchronization methods can be used to synchronize between the RUs of different operators, such as but not limited to PTP (Precision Time Protocol), GPS, and the like.

As illustrated, element 650 shows wireless operators using a shared RU. If two or more of the wireless operators share the same RU infrastructure 610C, orthogonality and synchronization can be achieved (e.g., using a single inverse fast fourier transform (IFFT) process).

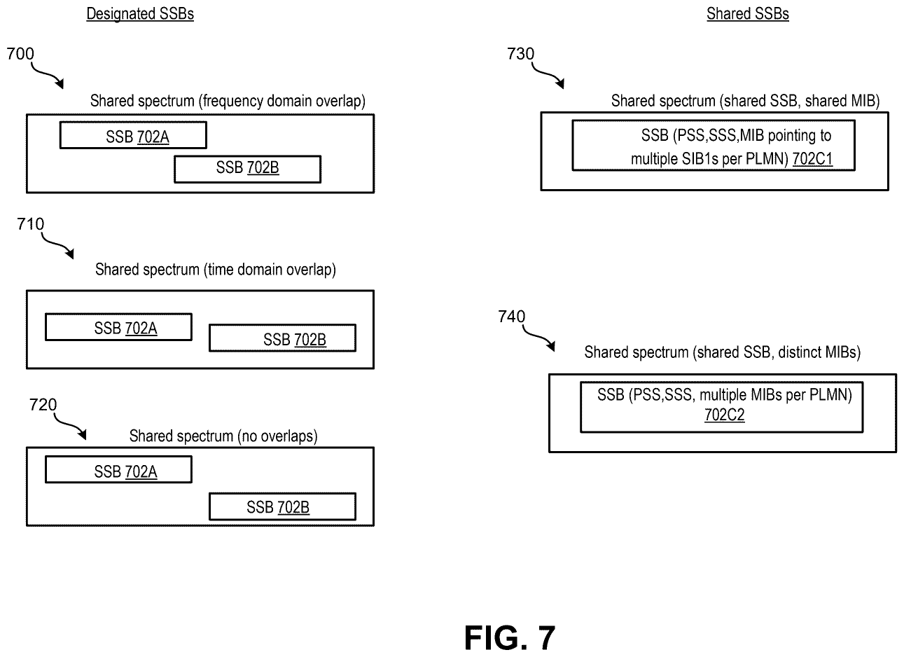

FIG. 7 illustrates an example of using designated synchronization signal blocks (SSBs), or shared SSBs in multi-operator spectrum sharing, according to various examples of the present disclosure.

In some examples, as illustrated by elements 700, 710, and 720 each wireless operator may transmit a different synchronization signal block (SSB) 702 to its UEs 110. According to other examples, as illustrated by elements 730 and 740, a shared SSB can be transmitted to the UEs of each of the wireless operators. Generally, a SSB is a signal transmitted by a base station that is used by a UE to synchronize with the cellular network by providing timing and frequency information that allows the UE to identify and connect to a nearby cell tower. As discussed above, a SSB 702 may include a primary synchronization signal (PSS), a secondary synchronization signal (SSS) alongside a physical broadcast channel (PBCH) that contains a master information block (MIB). When a UE 110 is searching for a network, the UE 110 detects the SSB 702 to identify a nearby cell and then decodes the MIB within the PBCH to determine network parameters, such as the System Frame Number (SFN), cell identity, subcarrier spacing, and other necessary system parameters for initial access.

According to some configurations, each wireless operator transmits its own SSB 702 (PSS, SSS, and PBCH/MIB) to provide time and frequency synchronization for the UEs 110 within the shared channel bandwidth. The SSBs 702 from different wireless operators can overlap in the frequency domain but not in the time domain as illustrated by element 700, overlap in the time domain but not in the frequency domain as illustrated by element 710, or not overlap in either the frequency domain or the time domain as illustrated by 720, based on the coordination or configuration between the different wireless operators.

In some examples, a single SSB 702C1 or SSB 702C2 (e.g., a shared SSB) is used for synchronization across the UEs 110 of the different wireless operators. According to some configurations, a shared SSB 702C1 can have a single PSS and a single SSS for all UEs 110. The PBCH/MIB could either be shared (e.g., if standardized) or each wireless operator can transmit its own distinct PBCH/MIB within the shared SSB framework.

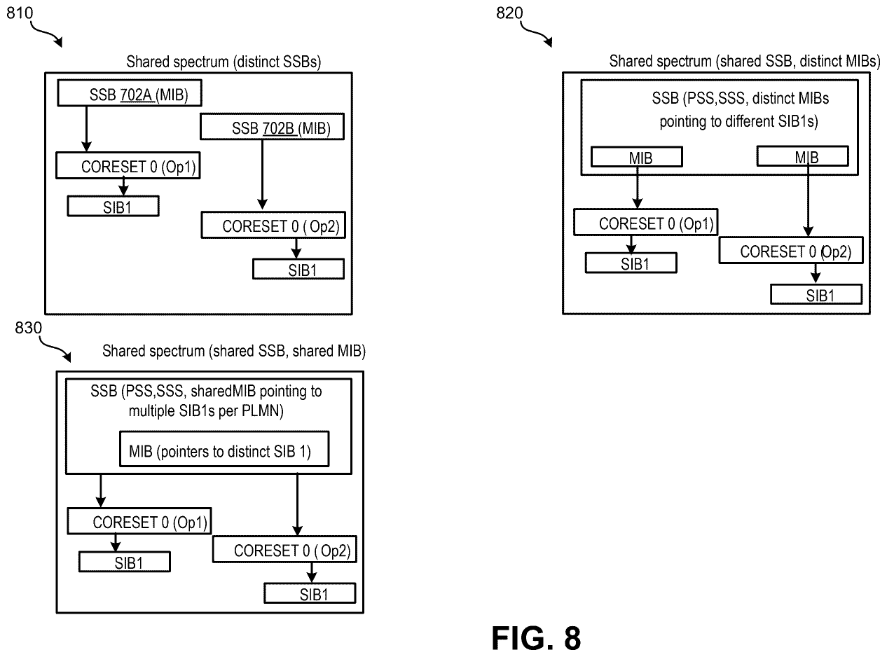

FIG. 8 illustrates an example of SSBs pointing to a control resource set (CORSET) in multi-operator spectrum sharing, according to various examples of the present disclosure.

Generally, CORESETs are used to transmit downlink control information (e.g., Downlink Control Information (DCI) messages), which instruct a UE on how to receive and process the data transmitted on the downlink. According to some examples, as illustrated by element 810, a distinct SIB1 & CORESET 0 is used by each wireless operator. For instance, each of the wireless operators can be allocated a unique SIB1 for transmitting system information to its UEs 110 and a distinct CORESET 0 that carries the PDCCH and DCI used for delivering the SIB1. The resource allocation for each CORESET 0 (time and frequency) can be determined by the PBCH which carries MIB. In some configurations, as illustrated by element 810 where each wireless operator transmits its own SSB, each MIB points to a distinct CORESET 0, which in turn points to the operator's unique SIB1.

When the different wireless operators transmit a shared SSB such as illustrated by elements 820 and 830, the MIB format can be modified to support multi-operator spectrum sharing. As illustrated by element 820, with distinct MIBs for each operator each shared SSB transmits multiple MIBs (e.g. if standardized), where each MIB points to a distinct CORESET 0 corresponding to the respective operator's SIB1. Element 830 illustrates when a single MIB is shared among multiple operators (e.g., if standardized), the MIB can be enhanced to carry information for multiple CORESET 0s, each pointing to a distinct SIB1 for different operators.

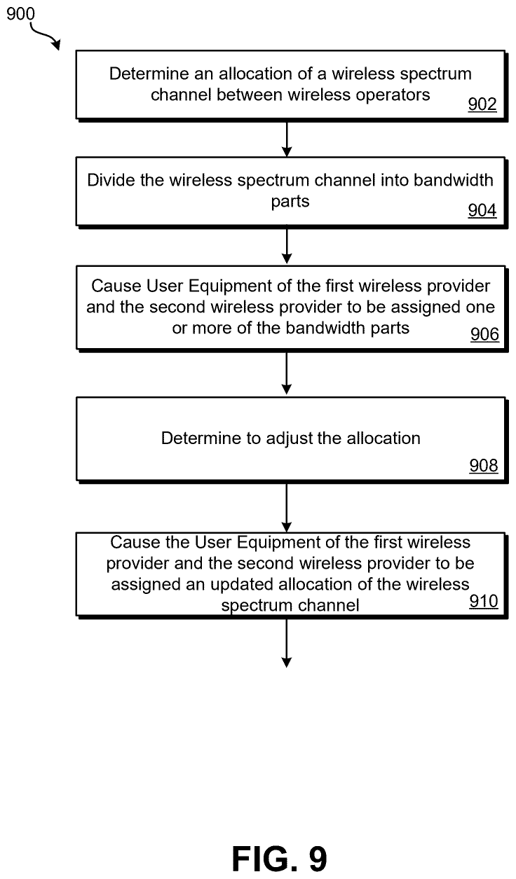

FIG. 9 is a flow diagram illustrating an example method 900 for multi-operator spectrum sharing, according to various examples. The method 900 may be implemented by one or more components included in the systems described herein. In some configurations, the method 900 is implemented by bandwidth allocation manager 122. Depending on the implementation, the method 900 may include additional, fewer, or alternative steps performed in various orders or in parallel.

At 902, an allocation of a wireless spectrum channel between wireless operators is determined. As discussed above, a wireless spectrum channel is allocated by a bandwidth allocation manager 122 to different wireless operators of a cellular network on a semi-static, or dynamic basis. According to some configurations, two or more wireless operators operating in a wireless cellular network can share licensed wireless spectrum without interference and with minimal coordination, leveraging semi-static or dynamic resource allocation.

At 904, the wireless spectrum channel is divided into sub-bands (e.g., bandwidth parts). As discussed above, each wireless operator that is sharing the wireless spectrum is allocated one or more of the sub-bands (e.g., BWPs) by the bandwidth allocation manager 122.

At 906, user equipment of the first wireless provider and the second wireless provider is assigned one or more of the bandwidth parts. As discussed above, the wireless operator, or some other component/device, can assign the allocated BWP(s) to one or more of the UEs of its subscribers. For example, as illustrated in FIG. 5, the bandwidth allocation manager 122 may allocate a first wireless operator a first sub-band (e.g., a BWP) of a first size and a second wireless operator a second sub-band of a second size. The first size of the first sub-band can be the same size and/or a different size compared to the second size of the second sub-band. The first operator may assign the first sub-band to one or more of the UEs of its subscribers, and the second wireless operator may assign the second sub-band to one or more of the UEs of its subscribers.

At 908, a determination is made to adjust the allocation. As discussed above, the bandwidth allocation manager 122 can change the allocated bandwidth for each wireless operator based on their contractual agreements with the mobile network operator by dynamically updating the BWPs associated with their UEs of its subscribers.

At 910, an updated allocation of the wireless spectrum channel is assigned to the user equipment of the first wireless provider and the second wireless provider. As discussed above, the wireless operator, or some other component/device, can assign the updated allocation.

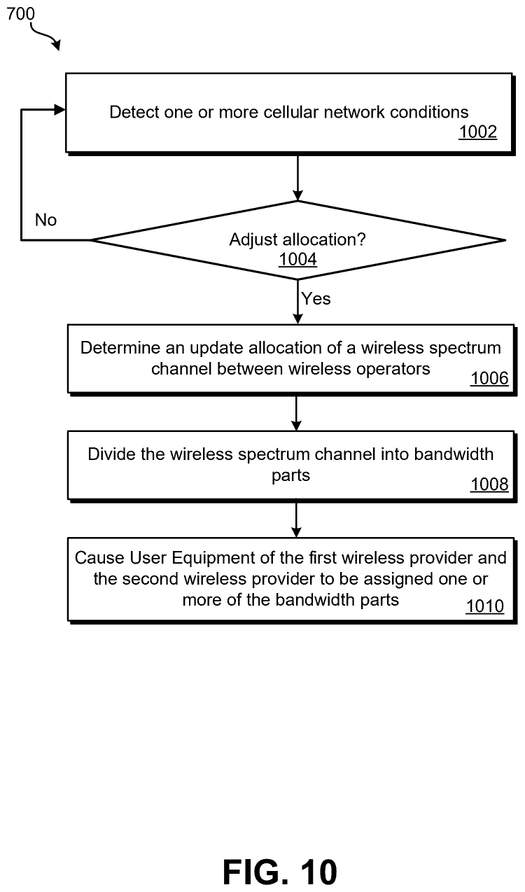

FIG. 10 is a flow diagram illustrating an example method 1000 for adjusting an allocation of wireless spectrum, according to various examples. The method 1000 may be implemented by one or more components included in the systems described herein. In some configurations, the method 1000 is implemented by bandwidth allocation manager 122. Depending on the implementation, the method 1000 may include additional, fewer, or alternative steps performed in various orders or in parallel.

At 1002, one or more cellular network conditions are detected. As discussed above, the detected network conditions can be based on contractual agreements, service level agreements (SLAs) that specify different parameters that can be used to switch between the different sub-bands (e.g., network conditions, traffic demands, and the like.

At 1004, a determination is made as to whether to adjust the allocation based on the detected cellular network conditions. When allocation is to be adjusted, the process moves to 1006. When the allocation is not to be adjusted, the process returns to 1002.

At 1006, an updated allocation of a wireless spectrum channel between wireless operators is determined. As discussed above, an update to allocation of the wireless spectrum channel determined by a bandwidth allocation manager 122.

At 1008, the wireless spectrum channel is divided into bandwidth parts. As discussed above, the wireless operator, or some other component/device, can determine an update to the BWPs based on the updated allocation.

At 1010, user equipment of the first wireless provider and the second wireless provider are assigned one or more of the bandwidth parts. As discussed above, the wireless operator, or some other component/device, can assign the updated allocation

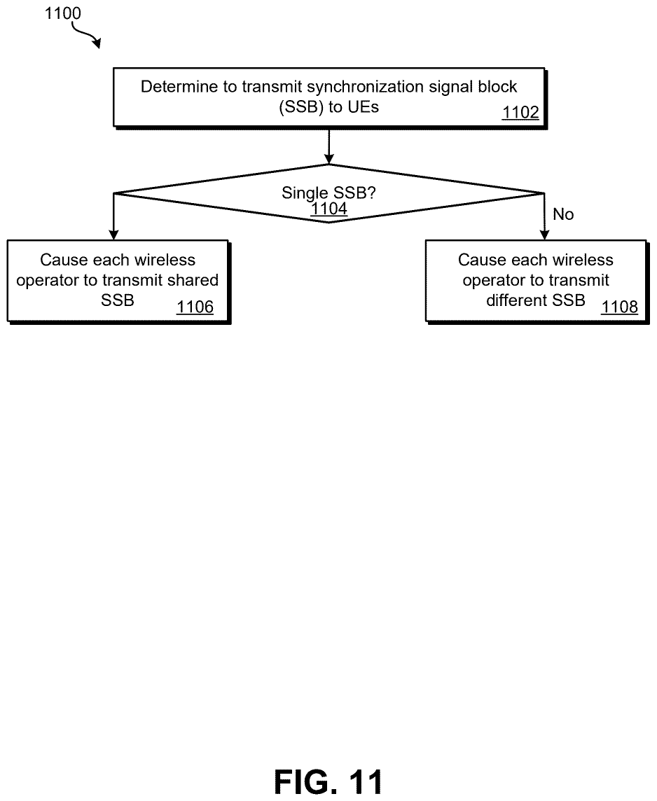

FIG. 11 is a flow diagram illustrating an example method 1100 for transmitting synchronization signal block (SSB) to UEs, according to various examples. The method 1100 may be implemented by one or more components included in the systems described herein. In some configurations, the method 1100 is implemented by bandwidth allocation manager 122. Depending on the implementation, the method 1100 may include additional, fewer, or alternative steps performed in various orders or in parallel.

At 1102, a determination is made to transmit synchronization signal block (SSB) to UEs. As discussed above, each wireless operator may transmit a synchronization signal block (SSB) to one or more of the UEs of its subscribers. According to some configurations, a shared SSB and/or a different SSB can be transmitted to the UEs of the wireless operators.

At 1104, a determination is made as to whether it is a single SSB. When it is a single SSB, the process moves to 1106. When the allocation is not to be adjusted, the process moves to 1108.

At 1106, each wireless operator transmits a shared SSB. As discussed above, the shared SSB can have a single PSS and a single SSS for all UEs. The PBCH/MIB could either be shared (e.g., if standardized) or each wireless operator can transmit its own distinct PBCH/MIB within the shared SSB framework.

At 1108, each wireless operator transmits a different SSB. As discussed above, each wireless operator transmits its own SSB (PSS, SSS, and PBCH/MIB) to provide time and frequency synchronization for the UEs within the shared channel bandwidth. The SSBs from different wireless operators can overlap in the frequency domain but not in the time domain, overlap in the time domain but not in the frequency domain, or not overlap in either the frequency domain or the time domain, based on the coordination or configuration between the different wireless operators

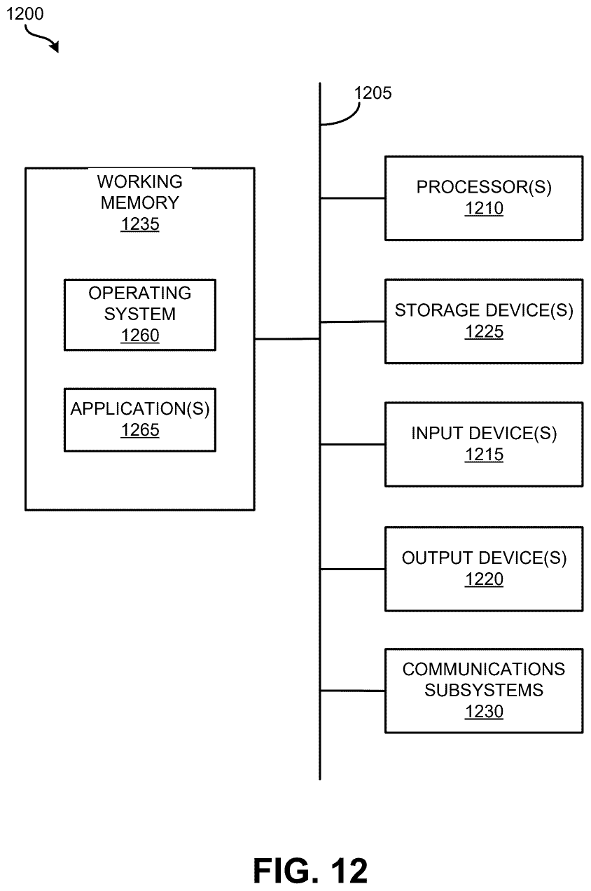

FIG. 12 provides a schematic illustration of one example of a computer system 1200 that can perform some or all of the steps of the methods and workflows provided by various examples. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner.

The computer system 1200 is shown including hardware elements that can be electrically coupled via a bus 1205, or may otherwise be in communication, as appropriate. The hardware elements may include one or more processors 1210, including without limitation one or more general-purpose processors and/or one or more special-purpose processors such as digital signal processing chips, graphics acceleration processors, and/or the like; one or more input devices 1215, which can include without limitation a mouse, a keyboard, a camera, and/or the like; and one or more output devices 1220, which can include without limitation a display device, a printer, and/or the like.

The computer system 1200 may further include and/or be in communication with one or more non-transitory storage devices 1225, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1200 might also include a communications subsystem 1230, which can include without limitation a modem, a network card (wireless or wired), an infrared communication device, a wireless communication device, and/or a chipset such as a Bluetooth™ device, a 1002.11 device, a WiFi device, a WiMax device, cellular communication facilities, etc., and/or the like. The communications subsystem 1230 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1230. In other examples, a portable electronic device, e.g., the first electronic device, may be incorporated into the computer system 1200, e.g., an electronic device as an input device 1215. In some examples, the computer system 1200 will further include a working memory 1235, which can include a RAM or ROM device, as described above.

The computer system 1200 also can include software elements, shown as being currently located within the working memory 1235, including an operating system 1260, device drivers, executable libraries, and/or other code, such as one or more application programs 1265, which may include computer programs provided by various examples, and/or may be designed to implement methods, and/or configure systems, provided by other examples, as described herein. Merely by way of example, one or more procedures described with respect to the methods discussed above, such as those described in relation to FIG. 12, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1225 described above. In some cases, the storage medium might be incorporated within a computer system, such as computer system 1200. In other examples, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 1200 and/or might take the form of source and/or installable code, which, upon compilation and/or installation on the computer system 1200 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some examples may employ a computer system such as the computer system 1200 to perform methods in accordance with various examples of the technology. According to a set of examples, some or all of the operations of such methods are performed by the computer system 1200 in response to processor 1210 executing one or more sequences of one or more instructions, which might be incorporated into the operating system 1260 and/or other code, such as an application program 1265, contained in the working memory 1235. Such instructions may be read into the working memory 1235 from another computer-readable medium, such as one or more of the storage device(s) 1225. Merely by way of example, execution of the sequences of instructions contained in the working memory 1235 might cause the processor(s) 1210 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an example implemented using the computer system 1200, various computer-readable media might be involved in providing instructions/code to processor(s) 1210 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1225. Volatile media include, without limitation, dynamic memory, such as the working memory 1235.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1200.

The communications subsystem 1230 and/or components thereof generally will receive signals, and the bus 1205 then might carry the signals and/or the data, instructions, etc. carried by the signals to the working memory 1235, from which the processor(s) 1210 retrieves and executes the instructions. The instructions received by the working memory 1235 may optionally be stored on a non-transitory storage device 1225 either before or after execution by the processor(s) 1210.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a segment” includes a plurality of such segments, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, “media content,” “media program,” “multimedia content,” “content,” or variants thereof should be understood as referring to any audiovisual programming or content in any streaming, file-based, or another format. The media content generally includes data that, when processed by a media player or decoder, allows the media player or decoder to present a visual and/or audio representation of the corresponding program content to a viewer (i.e., the user of a client device including the media player or decoder). In one or more examples, a media player can be realized as a piece of software that plays multimedia content (e.g., displays video and plays audio).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for spectrum sharing, comprising:
determining, using one or more processors, an allocation of a wireless spectrum channel between a first wireless operator and a second wireless operator within a cellular network;
dividing, using the one or more processors, the wireless spectrum channel into at least a first bandwidth part and a second bandwidth part based on the allocation;
causing, using the one or more processors, the first bandwidth part to be assigned to one or more first user equipment (UE) of the first wireless operator;
causing, using the one or more processors, the second bandwidth part to be assigned to one or more second UE of the second wireless operator;
determining, using the one or more processors, to adjust the allocation of the wireless spectrum channel between the first wireless operator and the second wireless operator; and
causing the one or more first UE of the first wireless operator and the one or more second UE of the second wireless operator to be assigned an updated allocation.

2. The method of claim 1, wherein determining the allocation of the wireless spectrum channel comprises:
dividing the wireless spectrum channel into non-overlapping transmission/receptions bandwidth parts, wherein the bandwidth parts include a first bandwidth part and a second bandwidth part;
assigning the first bandwidth part of the wireless spectrum channel to the first wireless operator; and
assigning the second bandwidth part of the wireless spectrum channel to the second wireless operator.

3. The method of claim 1, wherein determining to adjust the allocation comprises dynamically determining to adjust the allocation based at least in part on one more of a cellular network condition, or a traffic demand.

4. The method of claim 1, wherein a first bandwidth part of a UE can overlap with a second bandwidth part of the UE in both frequency range and location.

5. The method of claim 1, further comprising synchronizing a first RU associated with the first wireless operator with a second RU associated with the second wireless operator.

6. The method of claim 1, further comprising using a shared radio unit (RU) for the first wireless operator and the second wireless operator.

7. The method of claim 1, further comprising associating a first synchronization signal block (SSB) with the first operator and a second SSB with the second operator, wherein the first SSB and the second SSB can overlap in a frequency domain but not in a time domain or overlap in the time domain but not in the frequency domain, or not overlap in the frequency domain or the time domain.

8. The method of claim 1, further comprising associating a synchronization signal block (SSB) with the first operator and the second operator, wherein the SSB includes a common PSS and a common SSS for each of the UEs associated with the first operator and the second operator.

9. The method of claim 8, wherein a first MIB is associated with the first operator and a second MIB is associated with the second operator.

10. A system, comprising:
first devices associated with a first wireless operator wirelessly connected to a cellular network;
second devices associated with a second wireless operator wirelessly connected to the cellular network; and
a bandwidth allocation service connected to the cellular network that is configured to:
determine an allocation of a wireless spectrum channel between the first wireless operator and the second wireless operator;
divide the wireless spectrum channel into at least a first bandwidth part and a second bandwidth part based on the allocation;
cause the first bandwidth part to be assigned to one or more first user equipment (UE) of the first wireless operator;
cause the second bandwidth part to be assigned to one or more second UE of the second wireless operator;
determine to adjust the allocation of the wireless spectrum channel between the first wireless operator and the second wireless operator; and
cause the one or more first UE of the first wireless operator and the one or more second UE of the second wireless operator to be assigned an updated allocation.

11. The system of claim 10, wherein determining the allocation of the wireless spectrum channel comprises:
dividing the wireless spectrum channel into non-overlapping transmission/receptions bandwidth parts, wherein the bandwidth parts include a first bandwidth part and a second bandwidth part;
assigning the first bandwidth part of the wireless spectrum channel to the first wireless operator; and
assigning the second bandwidth part of the wireless spectrum channel to the second wireless operator.

12. The system of claim 10, wherein determining to adjust the allocation comprises dynamically determining to adjust the allocation based at least in part on one more of a cellular network condition, or a traffic demand.

13. The system of claim 10, wherein a first bandwidth part of a UE can overlap a second bandwidth part of the UE in both frequency range and location.

14. The system of claim 10, further comprising synchronizing a first RU associated with the first wireless operator with a second RU associated with the second wireless operator.

15. The system of claim 10, further comprising using a shared radio unit (RU) for the first wireless operator and the second wireless operator.

16. The system of claim 10, further comprising associating a first synchronization signal block (SSB) with the first operator and a second SSB with the second operator, wherein the first SSB and the second SSB can overlap in a frequency domain but not in a time domain or overlap in the time domain but not in the frequency domain, or not overlap in the frequency domain or the time domain.

17. The system of claim 10, further comprising associating a synchronization signal block (SSB) with the first operator and the second operator, wherein the SSB includes a common PSS and a common SSS for each of the UEs associated with the first operator and the second operator.

18. The system of claim 17, wherein a first MIB is associated with the first operator and a second MIB is associated with the second operator.

19. A non-transitory computer-readable storage media storing computer-executable instructions that when executed by the one or more processors, cause the one or more processors to:
determine an allocation of a wireless spectrum channel between a first wireless operator and a second wireless operator within a cellular network;
provide to one or more first user equipment (UE) of the first wireless operator and one or more second UE of the second wireless operator an indication of the allocation;
determine to adjust the allocation of the wireless spectrum channel between the first wireless operator and the second wireless operator; and
provide to the one or more first UE of the first wireless operator and the one or more second UE of the second wireless operator an indication of an updated allocation.

20. The non-transitory computer-readable storage media of claim 19, wherein determining the allocation of the wireless spectrum channel comprises:
dividing the wireless spectrum channel into non-overlapping transmission/receptions bandwidth parts, wherein the bandwidth parts include a first bandwidth part and a second bandwidth part;
assigning the first bandwidth part of the wireless spectrum channel to the first wireless operator; and
assigning the second bandwidth part of the wireless spectrum channel to the second wireless operator.
